(19) United States
(12) Patent Application Publication
(10) Pub. No.: US 2003/0157843 A1
(43) Pub. Date: Aug. 21, 2003

(54) Stacking connector with improper plug type prevention

(76) Inventor: Keith Thomas, Vermillion, SD (US)

Correspondence Address: GATEWAY, INC., ATTN: SCOTT CHARLES RICHARDSON, 610 GATEWAY DRIVE, MAIL DROP Y-04, N. SIOUX CITY, SD, 57049, US

(21) Appl. No.: 10/366,077

(22) Filed: Feb. 13, 2003

Related U.S. Application Data
(60) Provisional application No. 60/357,082, filed on Feb. 15, 2002.

(51) Int. Cl. H01R 13/64

(52) U.S. Cl. 439/680

(57) ABSTRACT

A stacked connector, suitable for use on a printed circuit board of a computer, for conserving connection space by providing two or more connector sockets, preferably oriented one atop the other. One or more of the connector sockets may be configured to prevent the insertion of an improper plug type having a similar form factor which is capable of being inserted into one of the sockets.

### CROSS REFERENCE TO RELATED APPLICATIONS

The present invention stems from, and claims priority to, U.S. provisional patent application serial No. 60/357,082 filed on Feb. 15, 2002, the entire contents of which are hereby incorporated by reference.

### FIELD OF THE INVENTION

The present invention generally relates to electrical connectors. More particularly, the present invention is related to ganged or stacked connectors for computers and related electronic devices including connectors which can prevent the insertion of an improper plug type.

### BACKGROUND OF THE INVENTION

As computers become smaller and smaller, “real estate”, e.g. physical space on the computer and circuit boards associated therewith, becomes more precious. Even desktop systems, which are also continuously being reduced in size, benefit from conservation of circuit board real estate since costs may be reduced by shrinking footprints and form factors and reducing the number of discreet components which must be inserted, assembled, and otherwise processed during manufacture. In addition, to the extent that the number of connection points increases, for example, parallel ports, serial ports, USB ports, network ports, telephone jacks, and the like, space must be conserved. The degree to which an increasing number of these connectors can be placed side by side on a circuit board such as a mother board becomes limited and thus real estate efficiency gains from interface connector placement is of paramount importance.

One area where gains may be achieved is in the area of the connectors themselves. Electrical connectors are extremely diverse in type and number. In computer systems, connectors are used in areas including, for example, communications, power distribution, data distribution, individual electrical signals, and the like. Conventional connectors for external interface such as communications interfaces or the like, are usually mounted directly along the surface of a circuit board as described, usually along the part of the circuit board corresponding to the back or side of the computer system. Although some gains may be made in minimizing the size of the connector housings, side by side placement of connectors still results in inefficient use of circuit board space as well as space along the back or side surfaces of the computer or electronics cabinet in which the circuit board is housed.

Another problem associated with the increase in the number of connectors provided on computer systems is the degree to which some standard connectors have sub-compatible form factors which can be cross-plugged. An example would be the cross-pluggability of RJ-11 plugs into RJ-45 jacks. Several devices have been proposed in attempts to prevent the insertion of the improper plug type. However, none of these devices teach or suggest a solution to the abovementioned problem concerning limited space on motherboards.

It should be noted that in modem computer applications, the RJ-45 connector series is typically used for network connections. Since, however, the RJ-45 jack was originally designed to accept both RJ-45 plugs as well as RJ-11 plugs, and since RJ-11 plugs are generally used to connect modems to phone lines, problems arise when inadvertent cross-plugging occurs. When an RJ-11 plug coupled, for example, to a phone system is plugged into the RJ-45 jack, the phone service associated with the RJ-11 line is disrupted until the RJ-11 plug is disconnected from the RJ-45 network jack. In addition, power pins associated with the RJ-11 plug may be connected to data lines associated with the RJ-45 jack with damaging results particularly during, for example, the generation of ring voltage or the like. It may also be possible to damage telephone equipment.

Consequently, it would be desirable to overcome the problem of connector bay crowding while preventing the insertion of RJ-11 plugs typically associated with phone lines into RJ-45 jacks typically associated with network connections.

### SUMMARY OF THE INVENTION

Accordingly, the present invention is directed to a stacked connector for conserving connection space by providing at least a first and second socket preferably one atop the other, and for preventing the insertion of an improper plug type capable of being inserted into one of the sockets.

In accordance with various exemplary embodiments, the stacked connector of the present invention preferably includes a housing having a first and second plug receiving cavity associated with the first and second sockets. The first plug receiving cavity, e.g. the one associated with the first socket and at least one of the plug types may include a plug prevention mechanism. It will be appreciated that the plug prevention mechanism is disposed within the first plug receiving cavity so as to be capable of contacting and preventing the improper plug type when the improper plug type is plugged into the first socket. It will further be appreciated that the plug type further includes an RJ-11 plug type and an RJ-45 plug type, with the improper plug type preferably including the RJ-11 plug type and the proper plug type preferably including the RJ-45 plug type.

In accordance with one embodiment, the plug prevention mechanism includes a blocking tab with a resilient curved portion and a finger extending into an upper narrow portion of the first plug receiving cavity, the finger being upwardly movable when the curved portion is pushed, e.g. by the proper plug. It should also be noted that it is preferable to have a complementary curved portion and finger on each side of the plug receiving cavity.

In accordance with another exemplary embodiment, the plug prevention mechanism includes a blocking tab comprising a flexible cantilevered arm, extending from a rear wall associated with the plug receiving cavity, formed integrally with the housing and having a distal free end projecting into the first plug receiving cavity. The flexible cantilevered arm preferably has a stop surface and a sliding surface. The stop surface may be positioned within the first plug receiving cavity for contacting a leading surface of the improper plug type, e.g. the RJ-11 plug type, when the improper plug type is inserted. Further insertion of the improper plug type into the first plug receiving cavity is thereby stopped. It should be noted that the sliding surface, beginning at the distal free end of the flexible cantilevered arm, which free end is located adjacent to a front wall of the housing, is positioned within the first plug receiving cavity a lateral distance from a width centerline of the plug receiving cavity such that the sliding surface will contact a leading surface associated with the proper plug type at a predetermined distance from the width centerline less than one half the proper plug width dimension and greater than one half the improper plug width dimension. Accordingly, the sliding surface slidably contacts the leading surface associated with the proper plug type as the proper plug type is inserted into the first plug receiving cavity causing the flexible cantilevered arm to bend such that the stop surface is moved out of the way and thus out of engagement with the leading surface of the proper plug type. Complete insertion thereof into the first plug receiving cavity is thereby allowed.

In accordance with yet another exemplary embodiment, the plug prevention mechanism of the present invention includes a deflection member formed of a metal sheet material, having a retention section, a ramp surface and a blocking tab. The retention member may be mounted, for example, in a slot in the housing, with the ramp surface extending into the first plug receiving cavity so as to be able to contact the proper plug type and the blocking tab may extend laterally from the ramp surface further into the first plug receiving cavity so as to contact and stop the insertion of the improper plug type. Accordingly, when the proper plug type is inserted into the first plug receiving cavity, the ramp surface is engaged and the blocking tab deflects away from the proper plug type thereby allowing insertion into the first plug receiving cavity. As described, the improper plug type will not contact the ramp surface and thus is stopped by the blocking tabs, preventing insertion thereof.

In accordance with still another exemplary embodiment, the plug prevention mechanism may be coupled to at least one opposite side wall associated with the housing and the first plug receiving cavity and may include at least one base portion engaged with the housing, at least one resilient arm extending from the base portion and positioned in a corresponding recess of the opposite side wall, and at least one baffle projecting from the resilient arm into the first plug receiving cavity for stopping the insertion of an improper plug type. The housing may further include at least one slot defined in the opposite side wall for receiving the base portion and for fixing the prevention mechanism, e.g. the base, the resilient arm, and the baffle, to the housing.

In accordance with still another exemplary embodiment, the plug prevention mechanism includes a base fixed to the housing, a resilient stem extending forwardly from the base and through a corresponding side wall of the housing and into the first plug receiving cavity. A curved force receiving portion may be formed near a free end of the resilient stem and a stop tongue located between the force receiving portion and the base and extending from the resilient stem into a channel defined in an upper wall of the housing. It should be noted that the curved portion projects a shorter distance from the corresponding side wall into the first plug receiving cavity than the stop tongue projects from the corresponding side wall into the channel.

In accordance with various alternative exemplary embodiments, in the stacked connector of the present invention, the second plug receiving cavity may be identical to the first plug receiving cavity, e.g. may have a plug prevention mechanism. Alternatively, the second plug receiving cavity may be configured to receive a plug type different from the plug type associated with the first plug receiving cavity, including any one of: an A type USB plug, a B type USB plug, and a RJ-11 plug type. As previously noted, the first and second plug receiving cavity are preferably configured in a manner one atop the other, or may alternatively be configured in a manner including one alongside the other. The stacked connector of the present invention may further including a third plug receiving cavity, wherein the first, second, and third plug receiving cavity are configured in a manner including one atop the other. In such an arrangement several combinations are possible, e.g. the first plug receiving cavity may be associated with an RJ-45 plug type and the second and third plug receiving cavity may be associated with a USB A plug type; or the first plug receiving cavity may be associated with an RJ-45 plug type and the second and third plug receiving cavity may be associated with a USB B plug type; or the first plug receiving cavity may be associated with an RJ-45 plug type, the second plug receiving cavity may be associated with a USB A plug type, and the third plug receiving cavity may be associated with a USB B plug type; or the first plug receiving cavity may be associated with an RJ-45 plug type, the second plug receiving cavity may be associated with a USB A plug type, and the third plug receiving cavity may be associated with an RJ-11 plug type; or the first plug receiving cavity may be associated with an RJ-45 plug type, the second plug receiving cavity may be associated with a USB B plug type, and the third plug receiving cavity may be associated with an RJ-11 plug type; or the first plug receiving cavity may be associated with an RJ-45 plug type and the second and third plug receiving cavity may be associated with a RJ-11 plug type.

In accordance with still another alternative exemplary embodiment, a stacked connector may be provided for conserving connection space having at least a first and second socket. The stacked connector may preferably comprise a housing; a first plug receiving cavity associated with the first socket; and a second plug receiving cavity associated with the second socket. The second plug receiving cavity may be configured with a plug prevention mechanism for preventing the insertion of an improper plug type. The plug prevention mechanism may be disposed within the first plug receiving cavity so as to be capable of preventing insertion of the improper plug type when the improper plug type is plugged into the first socket. As in other embodiments, the plug types may include an RJ-11 plug type, e.g. the improper plug type, and an RJ-45 plug type, e.g. the proper plug type. The first plug receiving cavity may be configured to receive a plug type including any one of: an A type USB plug, a B type USB plug, and a RJ-11 plug type. The first and second plug receiving cavity are configured in a manner including one atop the other or one alongside the other. A third plug receiving cavity may be included, wherein the first, second, and third plug receiving cavity are configured in a manner including one atop the other. The first plug receiving cavity is preferably associated with an RJ-45 plug type and the second and third plug receiving cavity are associated with a USB A plug type.

Alternatively, the first, second, and third plug receiving cavities may be associated in a number of combinations, e.g. the first plug receiving cavity may be associated with an RJ-45 plug type and the second and third plug receiving cavity may be associated with a USB B plug type; or the first plug receiving cavity may be associated with an RJ-45 plug type, the second plug receiving cavity may be associated with a USB A plug type, and the third plug receiving cavity may be associated with a USB B plug type; or the first plug receiving cavity may be associated with an RJ-45 plug type, the second plug receiving cavity may be associated with a USB A plug type, and the third plug receiving cavity may be associated with an RJ-11 plug type; or the first plug receiving cavity may be associated with an RJ-45 plug type, the second plug receiving cavity may be associated with a USB B plug type, and the third plug receiving cavity may be associated with an RJ-11 plug type; or the first plug receiving cavity may be associated with an RJ-45 plug type and the second and third plug receiving cavity may be associated with a RJ-11 plug type.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWING

The numerous advantages of the present invention may be better understood by those skilled in the art by reference to the accompanying figures in which:

FIG. 1 is a diagram illustrating a conventional connector area on an exemplary motherboard and several conventional single plug connectors;

FIG. 2 is a diagram illustrating a conventional connector area on an exemplary motherboard, several conventional single plug connectors, and stacked connectors in accordance with various exemplary embodiments of the present invention;

FIG. 3 is a diagram illustrating an exemplary stacked connector with an improper plug type prevention mechanism in accordance with various exemplary embodiments of the present invention;

FIG. 4 is a diagram illustrating an exemplary stacked connector with an improper plug type prevention mechanism in accordance with various exemplary alternative embodiments of the present invention;

FIG. 5 is a diagram illustrating an exemplary stacked connector with an improper plug type prevention mechanism in accordance with various exemplary alternative embodiments of the present invention;

FIG. 6 is a diagram illustrating an exemplary stacked connector with an improper plug type prevention mechanism in accordance with various exemplary alternative embodiments of the present invention;

FIG. 7 is a diagram illustrating an exemplary stacked connector with an improper plug type prevention mechanism in accordance with various exemplary alternative embodiments of the present invention; and

FIG. 8 is a diagram illustrating exemplary stacked connectors with 1×3 and 2×3 configurations in accordance with various alternative exemplary embodiments of the present invention

### DETAILED DESCRIPTION OF THE INVENTION

In accordance with various exemplary embodiments, the present invention solves the problem of connector bay crowding and cross-plugging by combining several connector socket types in a stacked connector and by preventing the insertion of an improperly inserted plug. Reference will now be made in detail to the presently preferred embodiments of the invention, examples of which are illustrated in the accompanying drawings.

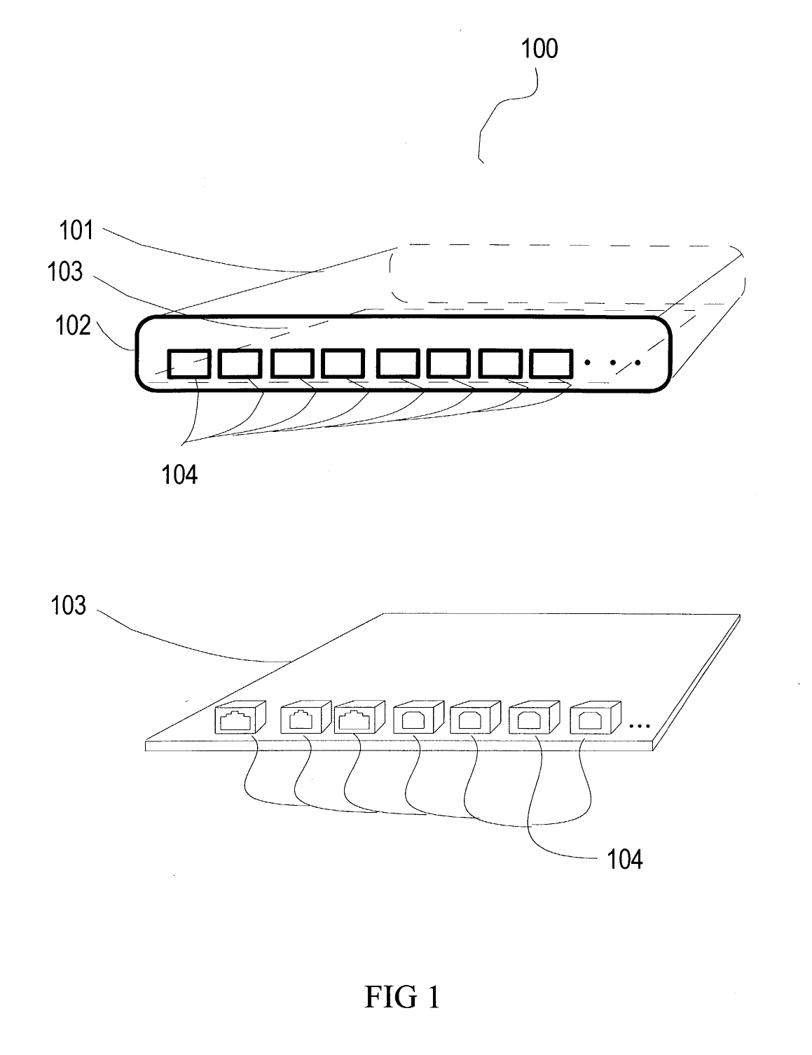

As can be seen from FIG. 1, exemplary connector scenario 100 is shown including computer enclosure 101. It should be noted that computer enclosure 101 is shown as, for example, a laptop enclosure, but can be an enclosure associated with any kind of computer or device. For example, computer enclosure 101 could be associated with a desktop computer, a laptop computer, a PDA, a handheld computer, or any kind of electronic device which makes use of external connectors. Computer enclosure 101 houses connector bay 102, and motherboard 103, and may further enclose components not shown such as, for example, a power supply, disk drives, and the like. Motherboard 103 may be configured to host several connector 104 of the same or different types including, RJ-11 connectors, RJ-45 connectors, parallel and/or serial “D” connectors, video connectors, USB connectors including A-type (large) and B-type (small), audio connectors, PS/2 connectors, and other proprietary and nonproprietary (e.g. standard) connectors. The connectors are generally mechanically fixed to motherboard 103 using any suitable conventional methods, with electrical connections being directly soldered to pads on motherboard 103, or, as in the case of a desktop computer, may be associated with a peripheral plug-in card, though many standard connectors will be present as part of a basic system. In either case, space along connector bay 102 is limited by, for example, the number of slots and the square area generally associated with the back of computer enclosure 101. It should be noted that an additional constraint on the amount of space available for connectors is the space required for air flow to cool, for example, the processor, the power supply, peripheral components, and the like. In some cases, connectors 104 may be mechanically coupled to connector bay 102 or computer enclosure 101 and wired to motherboard 101 using flexible wire, flex connectors, or the like. Regardless, space associated with connector bay 102 remains limited and as the number of connectors 104 supported increases, space along connector bay 102 becomes progressively scarce. It should further be noted that although typically associated with the back of computer enclosure 101, exemplary stacked connectors in accordance with the present invention may be used anywhere on computer enclosure 101 for convenience, e.g. placing connectors similar in function together, or where space is limited including the front and sides of computer enclosure 101.

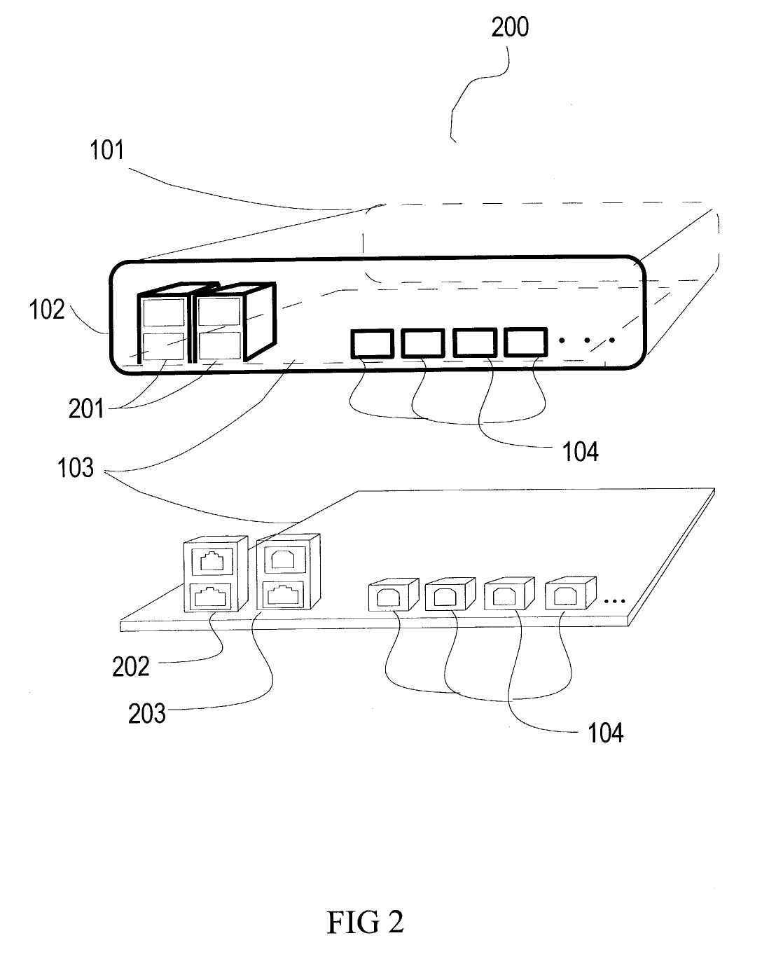

To address the problem of scarce space along connector bay 102, motherboard 103 may be configured with connectors in accordance with exemplary connector scenario 200 as shown in FIG. 2. Computer enclosure 101 may be configured with connector bay 102 as before, however motherboard 103 now is equipped with stacking connectors 201 for space conservation. It should be noted that although stacking connectors 201 are illustrated including two stacked connectors in accordance with an exemplary preferred embodiment of the present invention, three or more connectors may also be stacked. It can further be seen that stacking connectors 201 may include combinations of several jack or socket types such as exemplary connector 202 which is shown including RJ-11 and RJ45 jack types, and exemplary connector 203 which is shown including USB B (small) form factor jack type and RJ-45 jack type. Although the combinations shown are useful, one skilled in the art will appreciate that other combinations are also useful such as a stacked connector including USB A (large) and B (small) form factor jack types and the like. It should further be noted that while the figures show the USB B (small) form factor jack for illustrative purposes, the USB A (large) form factor jack is preferred but is not illustrated since well understood. Further, it will be appreciated that although the stacked configuration shows one jack generally atop the other jack, the stacked connector of the present invention in alternative exemplary embodiments may include side by side stacking coupled with a one atop the other configuration, e.g. a 2-by-N configuration or an N-by-N configuration where N is the number of jack types. It should also be appreciated by one of skill in the art that in the preferred the stacked configuration of the present invention preferably includes a improper plug preventing jack stacked with any one or more of: RJ-11 connector, RJ-12 connector, RJ-45 connector (with or without plug prevention and/or detection), network connectors, fiber optic connectors, RG-type coaxial connectors, USB connectors, PS/2 connectors, D type serial connectors, audio connectors including RCA-mini and the like, video connectors, PS/2 connectors, and any other proprietary and/or nonproprietary (e.g. standard) connectors that would be known to one of ordinary skill.

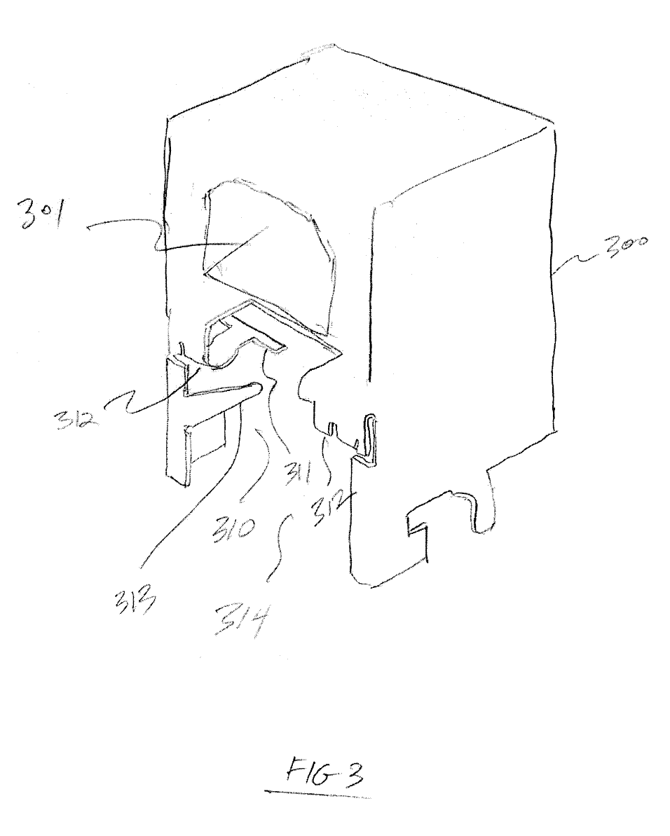

In addition to the problem of crowding, cross plugging problems are present and may lead to damage to equipment due to resulting improper cross-connections between, for example, voltage pins, ground pins, and data or signal pins. To alleviate the problem of potential electrical damage to equipment, exemplary stacked connector 300 is shown in FIG. 3 with exemplary USB B jack 301 and exemplary mechanism 310 for preventing the insertion of RJ-11 plug therein. It should be noted that such a mechanism is described in U.S. Pat. No. 6,458,001 B1 issued on Oct. 1, 2002 to Chen et al. Although Chen et al. adequately describe the construction of the prevention mechanism, Chen et al. fail to describe its use in a stacked connector arrangement. Another problem which occurs is the cross-pluggability problem which arises when a user improperly attempts to insert an RJ-11 plug into an RJ-45 jacks, or vice versa. This problem is described in greater detail, and a solution is provided, in the U.S. patent application filed on even date herewith and assigned to the same assignee of the present application entitled “RJ-45 Jack with RJ-11 Detection”, by Liebenow, Attorney docket no. P1915US00, the entire contents of which are hereby incorporated by reference in their entirety. In accordance with the mechanism described in Chen et al., and further in accordance with the stacked connector of the present invention, if an attempt is made to insert an improper RJ-11 plug into plug receiving cavity 314, blocking finger 311 of blocking tab 312 will prevent insertion thereof. Blocking tab 312 may be configured with a resilient curved portion and blocking finger 311 extending into an upper narrow portion of plug receiving cavity 314. Blocking finger 311 may be upwardly movable when the curved portion is pushed. Thus if a proper RJ-45 plug is inserted into plug receiving cavity 314, the body of the RJ-45 plug will contact the resilient curvate spring bias portion of blocking tab 312 pushing it along with blocking fingers 311 up and out of the way allowing full insertion thereof. It will be appreciated by one of ordinary skill in the art that although in the illustrated exemplary embodiment, mechanism 310 is shown as a housing, blocking tabs 312 may be easily incorporated into a molded receptacle as, for example, a resilient curved portion. It will further be appreciated that only one half of mechanism 310 is shown, e.g. blocking tabs 312 include a tab on each side of plug receiving cavity 314 with associated blocking fingers 311.

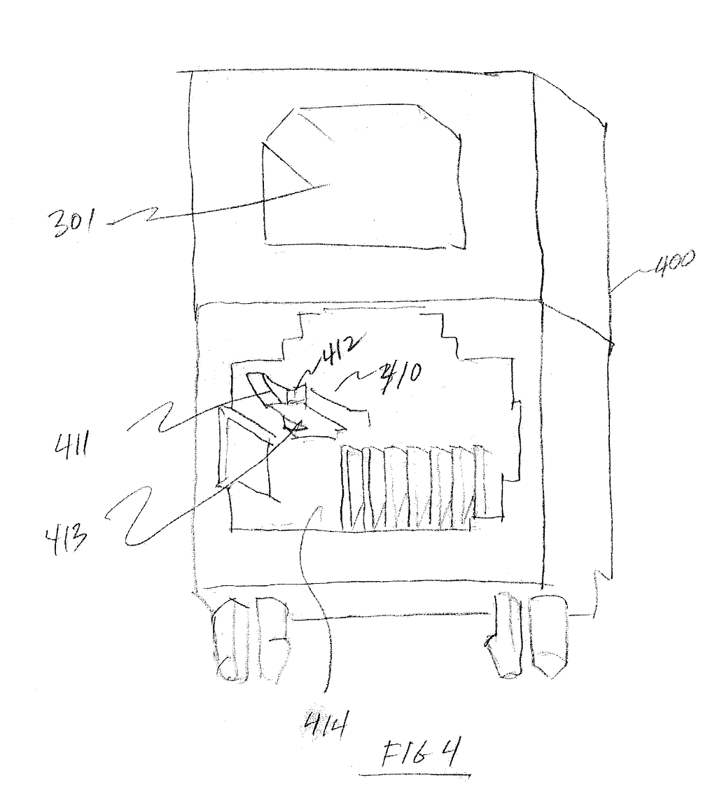

Another exemplary stacked connector in accordance with various exemplary alternative embodiments of the present invention is illustrated in FIG. 4. Therein, stacked connector 400 is shown with exemplary USB B jack 301 and exemplary mechanism 410 for preventing insertion of an RJ-11 connector therewithin. It should be noted that such a mechanism is described in U.S. Pat. No. 6,296,528 B1 issued on Oct. 2, 2001 to Roberts et al. Although Roberts et al. describe a prevention mechanism, Roberts et al. fail to describe its use in a stacked connector arrangement. In accordance with the mechanism described in Roberts et al., and further in accordance with the stacked connector of the present invention, blocking arm 413 may be connected to the back of plug receiving cavity 414 and may be spring biased and normally positioned, as shown, in the blocking position. It should be noted that sliding actuator surface 411 begins at a distal free end of a flexible cantilevered arm having a free end located adjacent to a front wall of the stacked connector housing. The flexible cantilevered arm may be positioned a lateral distance from a width centerline of plug receiving cavity 414 such that sliding actuator surface 411 will contact a leading surface associated with the proper plug type at a predetermined distance from the width centerline less than one half the proper plug width dimension and greater than one half the improper plug width dimension. Accordingly, sliding actuator surface 411 slidably contacts the leading surface associated with the proper plug type as the proper plug type is inserted into plug receiving cavity 414 causing the flexible cantilevered arm to bend such that stop surface 412 is moved out of the way and thus out of engagement with the leading surface of the proper plug type. Complete insertion thereof into plug receiving cavity 414 is thereby allowed. If an attempt is made to insert an improper RJ-11 plug into plug receiving cavity 414, the plug body will not contact sliding actuator surface 411 and consequently will be blocked by stop surface 412. Again, however, if a proper RJ-45 plug is inserted into plug receiving cavity 414, the body of the RJ-45 plug will contact sliding actuator surface 411 pushing it along with stop surface 412 up and out of the way allowing full insertion thereof. It will be appreciated by one of ordinary skill in the art that although in the illustrated exemplary embodiment, mechanism 410 is shown incorporated into a molded receptacle, it may be incorporated into a housing and configured to protrude through a molded receptacle or the like.

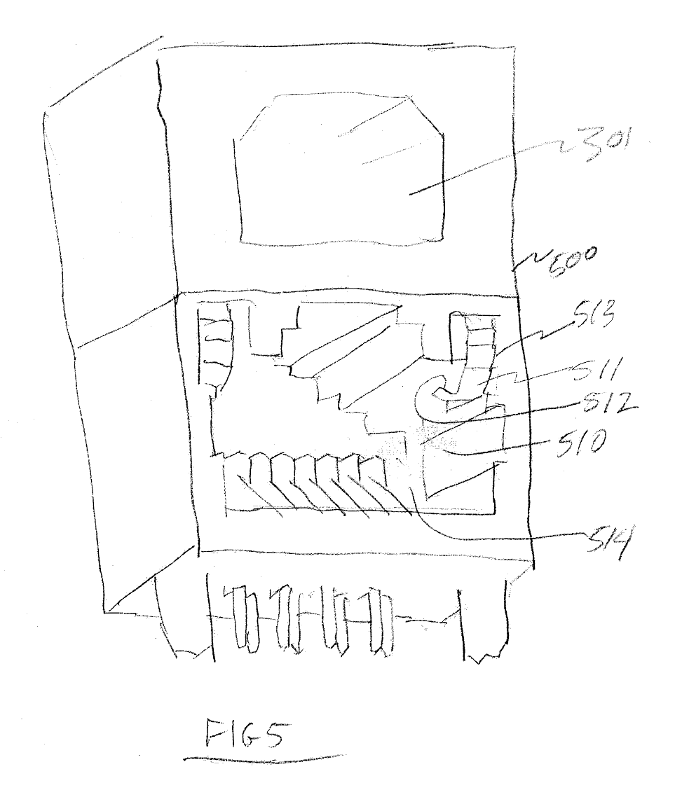

Another exemplary stacked connector in accordance with various exemplary alternative embodiments of the present invention is illustrated in FIG. 5. Therein, stacked connector 500 is shown with exemplary USB B jack 301 and exemplary mechanism 510 for preventing insertion of an RJ-11 connector therewithin. It should be noted that such a mechanism is described in U.S. Pat. No. 6,350,156 B1 issued on Feb. 26, 2002 to Hasircoglu et al. Although Hasircoglu et al. describe a prevention mechanism, Hasircoglu et al. fail to describe its use in a stacked connector arrangement. In accordance with the mechanism described in Hasircoglu et al., and further in accordance with the stacked connector of the present invention, deflection member 513 may be positioned within plug receiving cavity 514 such that ramp surface 511 is positioned to contact a properly inserted RJ-45 plug. Deflection member 513 may be formed of a metal sheet material and may have a retention section for mounting within, for example, a molded housing or the like and may further include ramp surface 511 as noted, and blocking or stopping tab 512. It will be appreciated that the retention member may be mounted, for example, in a slot in the housing, with ramp surface 511 extending into plug receiving cavity 514 so as to be able to contact the proper plug type and blocking or stopping tab 512 may extend laterally from ramp surface 511 further into plug receiving cavity 514 so as to contact and stop the insertion of the improper plug type. Accordingly, when the proper plug type is inserted into plug receiving cavity 514, ramp surface 511 is engaged and the blocking or stopping tab 512 deflects away from the proper plug type thereby allows insertion into plug receiving cavity 514. As described, the improper plug type will not contact ramp surface 511 and thus is stopped by blocking or stopping tab 512, preventing insertion thereof. More specifically, deflection member 513 may be spring biased and normally positioned, as shown, in the blocking position such that blocking or stopping tab 512 is positioned to prevent RJ-11 insertion. If an attempt is made to insert an improper RJ-11 plug into plug receiving cavity 514, the plug body will not contact ramp surface 511, will not push up on deflection member 513, and consequently will be blocked by blocking or stopping tab 512. If however, a proper RJ-45 plug is inserted into plug receiving cavity 514, the body of the RJ-45 plug will contact ramp surface 511 pushing it along with blocking or stopping tab 512 up and out of the way allowing full insertion thereof. It will be appreciated by one of ordinary skill in the art that although in the illustrated exemplary embodiment, mechanism 510 is shown separately attached into molded stacked connector 500, it may be incorporated during fabrication into the molded receptacle itself. It should further be noted that although the view illustrated in FIG. 5 allows only one side of the mechanism of the present invention to be seen, a complimentary portion of the mechanism is preferably present on the other side of plug receiving cavity 514.

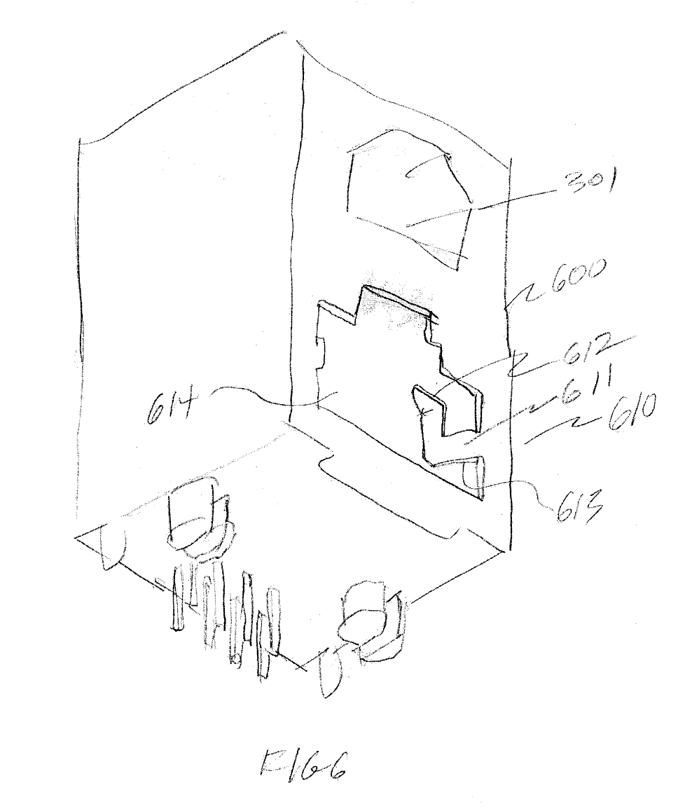

Still another exemplary stacked connector in accordance with various exemplary alternative embodiments of the present invention is illustrated in FIG. 6. Therein, stacked connector 600 is shown with exemplary USB B jack 301 and exemplary mechanism 610 for preventing insertion of an RJ-11 connector therewithin. It should be noted that such a mechanism is described in U.S. Pat. No. 6,312,293 B1 issued on Nov. 6, 2001 to Wang. Although Wang describes a prevention mechanism, Wang fails to describe its use in a stacked connector arrangement. In accordance with the mechanism described in Wang, and further in accordance with the stacked connector of the present invention, resilient arm also described as connecting arm 613 may include a base portion and may be positioned within plug receiving cavity 614 such that surface 611 of connecting arm 613 is positioned to contact a properly inserted RJ-45 plug. The housing may include a slot defined in an opposite side wall for receiving the base portion and for fixing the prevention mechanism, e.g. the base, resilient or connecting arm 613, and baffle 612, to the housing. Connecting arm 613 may be resilient, e.g. spring biased, and normally positioned, as shown, in the blocking position such that baffles 612 are positioned to prevent RJ-11 insertion. If an attempt is made to insert an improper RJ-11 plug into plug receiving cavity 614, the plug body will not contact surface 611, will not push on connecting arm 613, and consequently will be blocked by baffles 612. If however, a proper RJ-45 plug is inserted into plug receiving cavity 614, the body of the RJ-45 plug will contact surface 611 pushing it along with baffles 612 out of the way allowing full insertion thereof. It will be appreciated by one of ordinary skill in the art that although in the illustrated exemplary embodiment, mechanism 610 is shown separately attached onto, for example, a housing associated with molded stacked connector 600, it may be incorporated during fabrication into the molded receptacle itself or attached as a separate set of spring elements. It should further be noted that although the view illustrated in FIG. 6 allows only one side of the mechanism of the present invention to be seen, a complimentary portion of the mechanism is preferably present on the other side of plug receiving cavity 614.

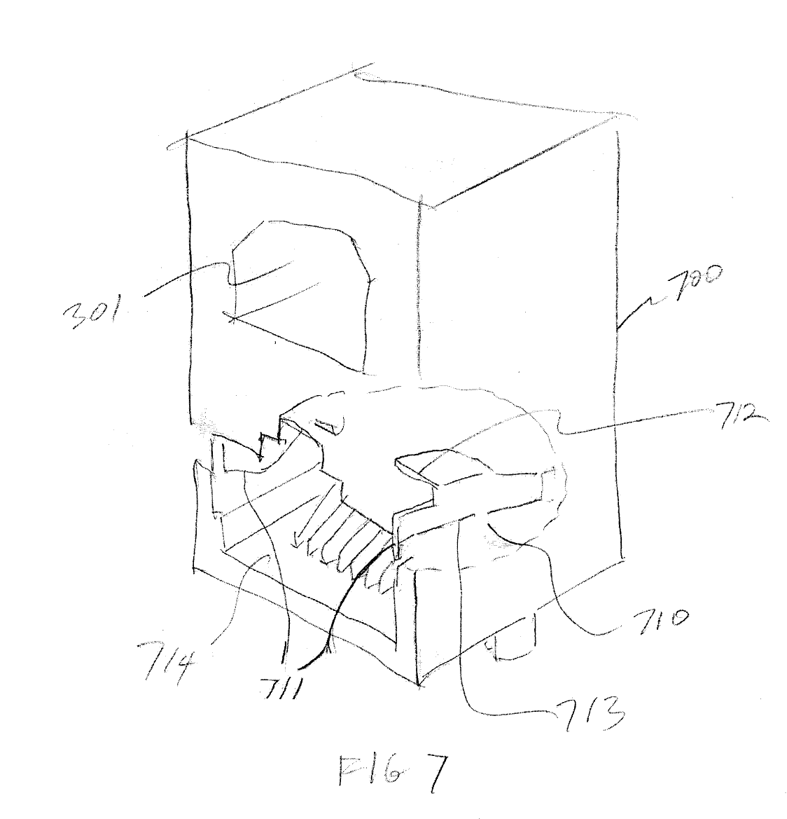

Still another exemplary stacked connector in accordance with various exemplary alternative embodiments of the present invention is illustrated in FIG. 7. Therein, stacked connector 700 is shown with exemplary USB B jack 301 and exemplary mechanism 710 for preventing insertion of an RJ-11 connector therewithin. It should be noted that such a mechanism is described in U.S. Pat. No. 6,257,935 B1 issued on Jul. 10, 2001 to Zhang et al. Although Zhang et al. describe a prevention mechanism, Zhang et al. fail to describe its use in a stacked connector arrangement. In accordance with the mechanism described in Zhang et al., and further in accordance with the stacked connector of the present invention, stem 713 may be positioned within plug receiving cavity 714 such that flared free end 711 of stem 713 is positioned to contact a properly inserted RJ-45 plug. Flared free end 711 may include a curved force receiving portion, stop tongue 712, and a base portion, and may extend from resilient stem 713 into a channel defined in an upper wall of the housing. It should be noted that the curved force receiving portion associated with flared free end 711 projects a shorter distance from the corresponding side wall into plug receiving cavity 714 than stop tongue 712 projects from the corresponding side wall into the channel. Stem 713 may be spring biased and normally positioned, as shown, in the blocking position such that linear stop face of stop tongue 712 are positioned to prevent RJ-11 insertion. If an attempt is made to insert an improper RJ-11 plug into plug receiving cavity 714, the plug body will not contact flared free end 711, will not push on stem 713, and consequently will be blocked by the linear stop face of stop tongue 712. If however, a proper RJ-45 plug is inserted into plug receiving cavity 714, the body of the RJ-45 plug will contact flared free end 711 pushing it along with stop tongue 712 out of the way allowing full insertion thereof. It will be appreciated by one of ordinary skill in the art that although in the illustrated exemplary embodiment, mechanism 710 is shown separately attached onto, for example, a housing associated with molded stacked connector 700, it may be incorporated during fabrication into the molded receptacle itself or attached as a separate set of spring elements. It should further be noted that although the view illustrated in FIG. 7 allows only one side of the mechanism of the present invention to be seen, a complimentary portion of the mechanism is preferably present on the other side of plug receiving cavity 714.

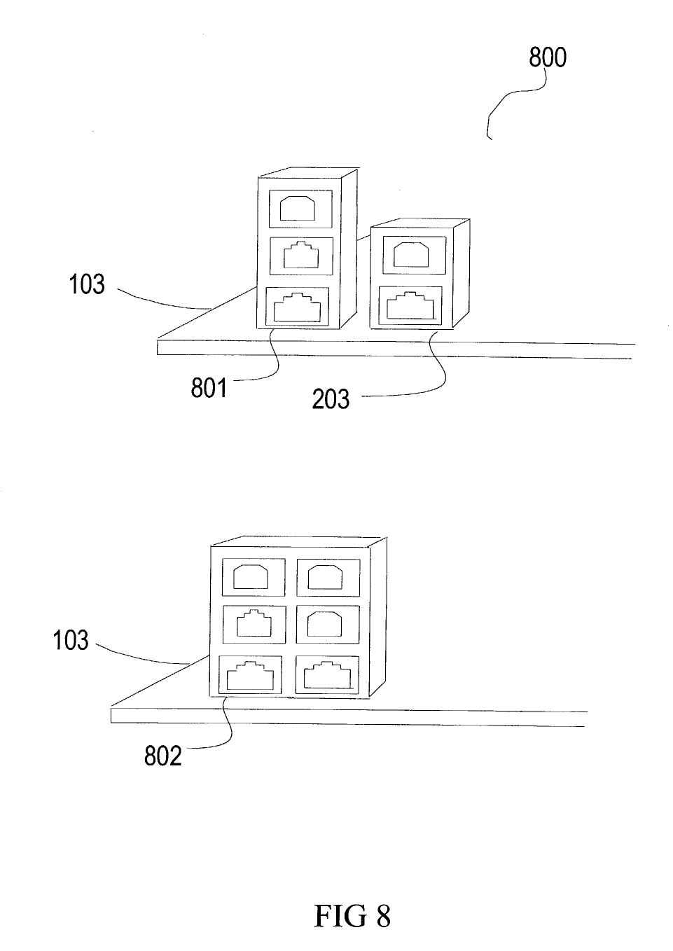

As previously described, the stacked connector of the present invention is not limited to a 1×2 configuration as has been shown for illustrative purposes, but can include up to N×N stacked connectors. It will be appreciated that the actual numbers of connectors in the stack will have practical limits however, N may include a number as great as three or even greater. FIG. 8 shows exemplary connector scenario 800 where exemplary stacked connector 801 having a 1×3 configuration is shown along side exemplary stacked connector 203 having a preferred 1×2 configuration. In accordance with still another alternative exemplary embodiment of the present invention, exemplary stacked connector 802 is shown having a 2×3 configuration.

In addition to the previously described plug prevention mechanisms, it will be appreciated by those skilled in the art that in accordance with various alternative exemplary embodiments, plug detection mechanisms, as described, for example, in the above-identified application to the present assignee, Gateway, Inc., entitled “RJ-45 Jack with RJ-11 Detection”, by Liebenow, Attorney docket no. P1915US00, may also be combined in the stacked connector configuration of the present invention to provide detection and, for example, notification through a software interface or the like of improper plug type insertion.

It is believed that the stacked connector of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A stacked connector for conserving connection space by providing at least a first and second socket, and for preventing one or more plug type capable of being inserted into the first socket, the stacked connector comprising:
a housing configured with a first and second plug receiving cavity associated with the first and second sockets, the first plug receiving cavity associated with the first socket and at least one of the one or more plug type; and
a plug prevention mechanism associated with the housing and the first plug receiving cavity;
wherein the one or more plug type includes a proper plug type and an improper plug type; and
wherein the plug prevention mechanism is disposed within the first plug receiving cavity so as to be capable of contacting and preventing the improper plug type when the improper plug type is plugged into the first socket.

2. The stacked connector as claimed in claim 1, wherein the one or more plug type comprises an RJ-11 plug type and an RJ-45 plug type, the improper plug type comprising the RJ-11 plug type and the proper plug type being the RJ-45 plug type.

3. The stacked connector as claimed in claim 1, wherein the plug prevention mechanism includes a blocking tab comprising a resilient curved portion and a finger extending into an upper narrow portion of the first plug receiving cavity, the finger being upwardly movable when the curved portion is pushed.

4. The stacked connector as claimed in claim 1, wherein the plug prevention mechanism includes a blocking tab comprising a flexible cantilevered arm, extending from a rear wall associated with the plug receiving cavity, formed integrally with the housing and having a distal free end projecting into the first plug receiving cavity, the flexible cantilevered arm having a stop surface and a sliding surface, the stop surface positioned within the first plug receiving cavity for contacting a leading surface of the improper plug type when the improper plug type is inserted into the first plug receiving cavity;
wherein further insertion of the improper plug type into the first plug receiving cavity is stopped and the sliding surface, beginning at the distal free end of the flexible cantilevered arm which free end is located adjacent to a front wall of the housing, is positioned within the first plug receiving cavity a lateral distance from a width centerline of the plug receiving cavity such that the sliding surface will contact a leading surface associated with the proper plug type at a predetermined distance from the width centerline, the predetermined distance being less than one half the proper plug width dimension and greater than one half the improper plug width dimension, to slidably contact the leading surface associated with the proper plug type as the proper plug type is inserted into the first plug receiving cavity, causing the flexible cantilevered arm to bend such that the stop surface is moved out of engagement with the leading surface of the proper plug type, thereby allowing complete insertion thereof into the first plug receiving cavity.

5. The stacked connector as claimed in claim 1, wherein the plug prevention mechanism includes a deflection member formed of a metal sheet material, having a retention section, a ramp surface and a blocking tab, the retention member being mounted in a slot in the housing, the ramp surface extending into the first plug receiving cavity and the blocking tab extending laterally from the ramp surface further into the first plug receiving cavity, wherein, when the proper plug type is inserted into the first plug receiving cavity, the ramp surface is engaged and the blocking tab deflects away from the proper plug type thereby allowing insertion into the first plug receiving cavity, and the improper plug type is stopped by the blocking tabs, thereby preventing insertion thereof.

6. The stacked connector as claimed in claim 1, wherein the plug prevention mechanism is coupled to at least one opposite side wall associated with the housing and the first plug receiving cavity and includes at least one base portion engaging with the housing, at least one resilient arm extending from the at least one base portion and positioned in a corresponding recess of the at least one opposite side wall, and at least one baffle projecting from the resilient arm and into the first plug receiving cavity, and wherein the housing further includes at least one slot defined in the at least one opposite side wall for receiving the base portion and for fixing the prevention mechanism to the housing.

7. The stacked connector as claimed in claim 1, wherein the plug prevention mechanism includes a base fixed to the housing, a resilient stem extending forwardly from the base and through a corresponding side wall of the housing and into the first plug receiving cavity, a curved force receiving portion formed near a free end of the resilient stem and a stop tongue located between the force receiving portion and the base and extending from the resilient stem into a channel defined in an upper wall of the housing, wherein the curved portion projects a shorter distance from the corresponding side wall into the first plug receiving cavity than the stop tongue projects from the corresponding side wall into the channel.

8. The stacked connector as claimed in claim 1, wherein the second plug receiving cavity is identical to the first plug receiving cavity.

9. The stacked connector as claimed in claim 1, wherein the second plug receiving cavity is configured to receive a plug type different from the plug type associated with the first plug receiving cavity.

10. The stacked connector as claimed in claim 1, wherein the second plug receiving cavity is configured to receive a plug type including any one of: an A type USB plug, a B type USB plug, and a RJ-11 plug type.

11. The stacked connector as claimed in claim 1, wherein the first and second plug receiving cavity are configured in a manner including one atop the other.

12. The stacked connector as claimed in claim 1, wherein the first and second plug receiving cavity are configured in a manner including one alongside the other.

13. The stacked connector as claimed in claim 1, further including a third plug receiving cavity, wherein the first, second, and third plug receiving cavity are configured in a manner including one atop the other.

14. The stacked connector as claimed in claim 13, wherein the first plug receiving cavity is associated with an RJ-45 plug type and the second and third plug receiving cavity are associated with a USB A plug type.

15. The stacked connector as claimed in claim 13, wherein the first plug receiving cavity is associated with an RJ-45 plug type and the second and third plug receiving cavity are associated with a USB B plug type.

16. The stacked connector as claimed in claim 13, wherein the first plug receiving cavity is associated with an RJ-45 plug type, the second plug receiving cavity is associated with a USB A plug type, and the third plug receiving cavity is associated with a USB B plug type.

17. The stacked connector as claimed in claim 13, wherein the first plug receiving cavity is associated with an RJ-45 plug type, the second plug receiving cavity is associated with a USB A plug type, and the third plug receiving cavity is associated with an RJ-11 plug type.

18. The stacked connector as claimed in claim 13, wherein the first plug receiving cavity is associated with an RJ-45 plug type, the second plug receiving cavity is associated with a USB B plug type, and the third plug receiving cavity is associated with an RJ-11 plug type.

19. The stacked connector as claimed in claim 13, wherein the first plug receiving cavity is associated with an RJ-45 plug type and the second and third plug receiving cavity are associated with a RJ-11 plug type.

20. A stacked connector for conserving connection space by providing at least a first and second socket, the stacked connector comprising:
a housing;
a first plug receiving cavity associated with the first socket; and
a second plug receiving cavity associated with the second socket, the second plug receiving cavity configured with a plug prevention mechanism for preventing the insertion of one or more plug type;
wherein the one or more plug type includes a proper plug type and an improper plug type, and wherein the plug prevention mechanism is disposed within the first plug receiving cavity so as to be capable of preventing the improper plug type when the improper plug type is plugged into the first socket.

21. The stacked connector as claimed in claim 20, wherein the one or more plug type further includes an RJ-11 plug type and an RJ-45 plug type and wherein the improper plug type includes the RJ-11 plug type and the proper plug type includes the RJ-45 plug type.

22. The stacked connector as claimed in claim 20, wherein the first plug receiving cavity is configured to receive a plug type including any one of: an A type USB plug, a B type USB plug, and a RJ-11 plug type.

23. The stacked connector as claimed in claim 20, wherein the first and second plug receiving cavity are configured in a manner including one atop the other.

24. The stacked connector as claimed in claim 20, wherein the first and second plug receiving cavity are configured in a manner including one alongside the other.

25. The stacked connector as claimed in claim 20, further including a third plug receiving cavity, wherein the first, second, and third plug receiving cavity are configured in a manner including one atop the other.

26. The stacked connector as claimed in claim 25, wherein the first plug receiving cavity is associated with an RJ-45 plug type and the second and third plug receiving cavity are associated with a USB A plug type.

27. The stacked connector as claimed in claim 25, wherein the first plug receiving cavity is associated with an RJ-45 plug type and the second and third plug receiving cavity are associated with a USB B plug type.

28. The stacked connector as claimed in claim 25, wherein the first plug receiving cavity is associated with an RJ-45 plug type, the second plug receiving cavity is associated with a USB A plug type, and the third plug receiving cavity is associated with a USB B plug type.

29. The stacked connector as claimed in claim 25, wherein the first plug receiving cavity is associated with an RJ-45 plug type, the second plug receiving cavity is associated with a USB A plug type, and the third plug receiving cavity is associated with an RJ-11 plug type.

30. The stacked connector as claimed in claim 25, wherein the first plug receiving cavity is associated with an RJ-45 plug type, the second plug receiving cavity is associated with a USB B plug type, and the third plug receiving cavity is associated with an RJ-11 plug type.

31. The stacked connector as claimed in claim 25, wherein the first plug receiving cavity is associated with an RJ-45 plug type and the second and third plug receiving cavity are associated with a RJ-11 plug type.
